(19) United States
(12) Patent Application Publication
(10) Pub. No.: US 2013/0223509 A1
(43) Pub. Date: Aug. 29, 2013

(54) CONTENT NETWORK OPTIMIZATION UTILIZING SOURCE MEDIA CHARACTERISTICS

(71) Applicants: Paul Tweedale, Andover, MA (US); Prubhudev Navali, Westford, MA (US)

(72) Inventors: Paul Tweedale, Andover, MA (US); Prubhudev Navali, Westford, MA (US)

(73) Assignee: Azuki Systems, Inc., Acton, MA (US)

(21) Appl. No.: 13/608,106

(22) Filed: Sep. 10, 2012

Related U.S. Application Data
(60) Provisional application No. 61/604,243, filed on Feb. 28, 2012.

(51) Int. Cl. H04N 11/02

(52) U.S. Cl. 375/240.01; 375/E07.026

(57) ABSTRACT

Content is prepared for delivery to a user device by creating multiple encodings that are then stored in a content delivery network. Encodings range from a minimum-rate encoding to a maximum-rate encoding. For each segment of the content, a dynamics metric is compared to thresholds defining intervals of a dynamic range. The intervals, ranging from a minimum-dynamics interval to a maximum-dynamics interval, represent corresponding levels of dynamics and are mapped to corresponding encodings. The comparing results in selection of an encoding based on the dynamics metric, which may be a scene change count that reflects the number of independently renderable frames in the segment, available in MPEG encoding. Selections are included in download control data used by the user device to download the content. The user device selectively retrieves different encodings of segments, achieving lower bandwidth usage without sacrificing fidelity.

### BACKGROUND

Multimedia content such as audio/video may be preprocessed before transmission to users on either wired or wireless networks to ensure efficient use of the network and client device resources, while still providing a high quality end user viewing experience.

In one preprocessing and delivery approach, audio/video content is encoded into discrete segments of constant intervals of time, which are transmitted sequentially to an end device for playback. These discrete segments maybe encoded using advanced audio/video codecs such as AAC and H.264 respectively. These codecs provide excellent compression and are readily available for both encode and decode. It is known to use bitrate-switching techniques for content delivery, such as HTTP Live Streaming (HLS), in which content is encoded into sets of segments of different bitrates and appropriate-rate segments bitrate are dynamically selected for delivery based on available network bandwidth. This technique enables the network and client to manage the use of available bandwidth while delivering the best quality content. Typically, only the demands of the network and client are factors in deciding which segment should be transferred at a given instant, and generally the highest-bitrate segment that does not over-use the available bandwidth is selected, on the assumption that such an approach delivers the highest quality viewing experience.

### SUMMARY

A high quality end user experience, i.e. viewing of content such as a video, does not necessarily require the transfer of the highest possible bitrate segment all the time (based on network bandwidth availability for example). In many cases, a video segment may have relatively little motion or other action, generally “dynamics”, that require high bitrate encoding for fidelity. If such segments can be accurately identified and their delivery needs quantified, then there is the possibility of delivering lower-bitrate encoded segments even when higher-bitrate delivery is permitted by network conditions. Such an approach can provide benefits in the form of more efficient use of network and user device (client) resources, without sacrificing end user viewing experience.

Thus a technique is disclosed for utilizing inherent characteristics of the source content to intelligently select among different bitrate segments to transfer. The technique provides benefit to the network and end user device in terms of bandwidth usage and allocated resources, without unacceptably degrading user viewing experience.

In particular, a method is disclosed of preparing content for segmented delivery to a user device over a network. The method includes creating a number of encodings of a content item and storing the encodings in a content delivery network, wherein the encodings range from a minimum-rate encoding to a maximum-rate encoding. The encodings are created on a per-segment basis and result in sequences of different-rate encoded segments for each segment-length portion (also referred to as “segment”) of the content item.

For each segment of the content item, a dynamics metric for the segment is compared to a set of thresholds defining intervals of a dynamic range of the content. The intervals range from a minimum-dynamics interval to a maximum-dynamics interval, where the maximum-dynamics interval represents a maximum level of dynamics and is mapped to a corresponding one of the encodings, and successively lower-dynamics intervals represent successively lower levels of dynamics in the content and are mapped to successively lower-rate ones of the encodings. The comparing results in selection of an encoding of the segment to be delivered, based on the interval containing the dynamics metric. In one embodiment, the dynamics metric is in the form of a scene change count or rate that reflects the number of independently renderable video frames in the segment. Scene change indications are commonly available in systems employing MPEG encoding.

Download control data is created and made available to the user device for use in downloading the content from the content delivery network for local rendering. The download control data includes an identification of the selected encoding for each of the segments of the content item. The user device uses this information to selectively retrieve different encodings of segments during the download of the content, taking advantage of lower dynamics in the content where possible to use correspondingly less local resources and download bandwidth while preserving acceptable fidelity.

The disclosed technique may find particular applicability in systems employing HTTP Live Streaming (HLS) or similar bitrate-switching techniques that support user devices capable of seamlessly switching between bitrates, on a per segment basis, as required by the network environment. This technique allows for high quality media playback under varying conditions, without the need for any user intervention. One benefit in HLS or similar systems is that they already provide content segments that are encoded at different bitrates, used to accommodate changing network bandwidth conditions. The presently disclosed technique can make separate use of these existing segments to switch bitrates based on characteristics of the source content and make more efficient use of available bandwidth. An illustration of the disclosed technique in an HLS system appears below.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a block diagram of a content preparation and delivery system;

FIG. 2 is a graph presenting an example bitrate segment profile;

FIG. 3 is a flow diagram of a process of content preparation;

FIG. 4 is a graph presenting an example of bitrate selection based on both dynamics and network conditions; and

FIG. 5 is a block diagram of a content delivery system according to another embodiment.

### DETAILED DESCRIPTION

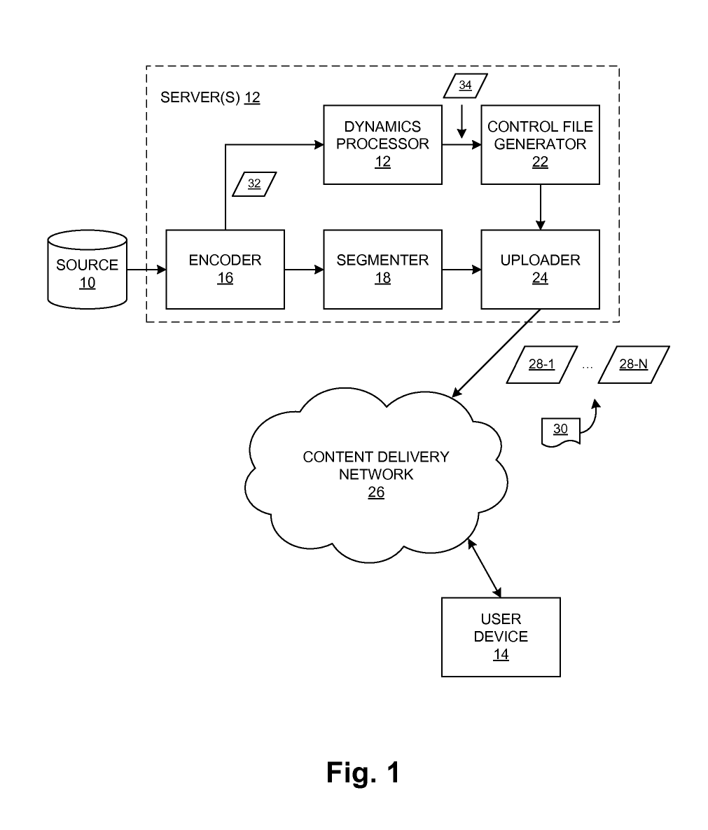

FIG. 1 shows a simplified block diagram of a content preparation and delivery system. In this embodiment, source content 10 is provided to one or more server computers (servers) 12 that perform a set of operations to make the content available for downloading and playback by user devices 14. In particular, a software and/or hardware “client” on the user device 14 is responsible for download and playing back the content. The source content 10 may be from a static media file or a streamed source, and may be available locally or received via an external network. The server(s) 12 include a combination of hardware and software collectively forming an encoder 16, segmenter 18, dynamics processor 20, control file generator 22, and uploader 24. These functional elements may have their operations tailored by configuration data from a separate configuration element or sub-system (not shown in FIG. 1). The server(s) 12 are coupled to one or more content delivery networks or CDN(s) 26 to which the processed content is uploaded for retrieval by the user devices 14. As generally known in the art, a CDN 26 may be formed as a logical overlay on a physical network, including the use of so-called “over the top” or OTT delivery in carrier networks. A user device 14 may be any of a number of types, including desktop or portable computers, tablet computers, smartphones, etc.

Overall operation of the servers 12 is to process the source content 10 to generate sets of encoded content segments 28-1, . . . , 28-N (generally 28) which can be downloaded from the CDN 26 by the user device 14 for local rendering (playback). Each set 28-i is encoded at a different bitrate as explained below. The servers 12 may also apply encryption or some other protection as part of a digital rights management (DRM) scheme for the content 10. In this case, the encryption function may be included as part of the segmenter 18. The servers 12 also generate a control file 30 for each processed source content item (e.g., video). The control file 30 contains information usable by the user device 14 in downloading the segments 28 of the content item.

The encoder 16 consumes the source content 10 and provides the segmenter 18 with encoded data streams at different bitrates, as may be specified by configuration information provided from a separate configuration element as mentioned above. Specific examples of bitrates are described below. As the source content 10 may already have some form of encoding applied, the encoder 16 may include a front-end decoder in order to first obtain a non-encoded version of the source content 10, which is then re-encoded at the different bitrates. Thus in some embodiments the encoder 16 may also be referred to as a transcoder. Each different-rate encoded stream is divided by the segmenter 18 into fixed-duration intervals, generally from about 1 second to about 10 seconds in length, which correspond to the segments 28. Thus the output from the segmenter 18 is a plurality of sequences of segments 28, where the segments 28-i of each sequence i are encoded at a corresponding different bitrate. The encoded segments 28 are uploaded to the CDN 26 by the uploader 24.

The encoder 12 also provides statistics and data on characteristics of the source content 10 and encoded output, in particular information about a level of dynamics in sections of the content. “Dynamics” in this context refers to an amount of change occurring in the video, audio or other subject of the content that translates to encoded information. In a video, for example, a low-dynamic section might be a scene of a landscape or a fairly stationary subject (such as a person talking) under constant lighting conditions, while a high-dynamic section might be a scene with a lot of motion, abrupt transitions, impulsive effects such as lightning, etc.

In the context of video in particular, dynamics may be reflected in so-called “scene change data”. In MPEG encoding, the encoding process calculates a metric for every frame to calculate how different it is from the previous frame. This metric is a so-called “scene change” indication, used to indicate the need for a new MPEG “independent frame” or I-frame in the encoded output. I-frames are independently renderable—they do not rely on information from any preceding frames. In the present technique, of interest is the number of scene changes in each segment of encoded output, as a low number indicates that the segment has relatively low dynamics and thus may be a good candidate to deliver at a lower bitrate without reducing fidelity. As an example of scene change rates, with a fixed frame rate of 30 frames per second (fps) and a segment duration of 10 seconds (300 frames), if there are 50 scene change detections between frames 300 and 600 (segment 2 of a video), then this segment has a scene change metric (dynamics metric) of 50.

Thus in one embodiment the encoder 16 provides media scene change data 32 that occurs at given frames within the content. The scene change data 32 is used by the dynamics processor 20 to calculate the number of scene changes that occur within a given segment being generated by the segmenter 18. The number of scene changes varies depending on the content. In this type of embodiment the dynamics processor 20 may be referred to as a “scene change analyzer”. Generally, the dynamics processor 20 executes an algorithm that uses predefined or dynamic thresholds to calculate the appropriate bitrate encoded segment that should be used for a given content segment to achieve both satisfactory playback as well as conserve network bandwidth usage. The thresholds define intervals of dynamic range of the content, from high dynamics to low dynamics. A bitrate segment profile 34 is used by the control file generator 22 to construct a control file 30 that can be used by the user device 14 to select which encoded segments should be retrieved from the CDN 26. The control file 30, or a set of control files 30, may be tailored to support standard formats such as HTTP Live Streaming (HLS) as well as proprietary formats. The bitrate segment profile 34 is also used by the encoder 16 and segmenter 18 to create the appropriate segments.

In other embodiments, other metrics may be used to gauge the relative motion or other dynamics characteristics (audio and/or video) within a source content item to identify time periods in the content that require different allocation of bandwidth. Additionally, other external information about the content item may be available and used as a component or scaling factor for the metrics. For example, if a content item is known to generally contain a lot of motion (i.e. an “action movie”) then a weighting or scaling factor may be additionally applied in the selection of bitrates. The table below provides an example of scaling factors that may be used as a function of encoded bitrates and screen resolution of the user device 14:

User Device Target Resolution

| Bitrates | ≦480x | ≦640x | ≦1280x | ≦1920x |
|---|---|---|---|---|
| Audio Only | X | X | X | X |
| 200K | 0.75 | X | X | X |
| 400K | 0.75 | 0.5 | X | X |
| 600K | 0.75 | 0.5 | X | X |
| 800K | 0.75 | 0.5 | 0.5 | X |
| 1.2M | X | 0.5 | 0.5 | 0.25 |
| 2.4M | X | X | 0.5 | 0.25 |
| 3.2M | X | X | 0.5 | 0.25 |

In one embodiment, a maximum scene change metric for a content item may be calculated and stored for use in calculating an appropriate set of thresholds for scene-change-based switching of delivery bitrates. Other embodiments may look at the maximum scene change metric across a dynamic window of time; this would be particularly applicable for live streaming applications.

Depending on the end-user device target screen resolution, a minimum bitrate and scaling factor are obtained. The table above provides an example matrix of scaling factors that might be used. The maximum scene change metric is then multiplied by the scaling factor and divided by the total number of unique bitrates available (ranging from the minimum to the maximum). This then results in a “step” value that is used as accumulative threshold for each of the bitrates. This operation can be described in pseudocode as follows:

for (i=0; i<ALL_SEGMENTS; i++) {

value = 0;
for (k=MIN_BITRATE_AVAILABLE;
k<MAX_BITRATE_AVAILABLE; k++) {

if (segment_scenecut_count[i] >= value) {

segment_bitrate[i] = k;

}
value +=step;

}

}

In the above, “segment-scenecut-count” refers to the number of scene changes in a segment. In addition to the above, a check may be made to increase the bitrate selection if the minimum bitrate is selected for a segment but the scene change metric is greater than zero.

The following outlines the operation of the system:
1. The configuration sub-system configures the system.
2. The encoder 12 consumes the source content 10 and generates the media scene change data 32. This may be done in conjunction with generating encoded data for the segmenter 18 or as an independent step.
3. The dynamics processor 20 executes an algorithm to determine the optimal bitrate segment profile for the content. An example of such a profile is described below.
4. The encoder 12 in conjunction with the segmenter 18 and uploader 24 stores the encoded segments 28 in the CDN 26.
5. The control file generator 22 creates a control file 30 that captures the bitrate profile generated by the dynamics analyzer 20. The control file 30 is then uploaded to the CDN 26 via the uploader 24.
6. The user device 14 downloads the control file 30, uses its contents to download the segments 28, and performs playback of the content using the downloaded segments. Generally, the user device 14 will download different-rate segments based on the profile as reflected in the control file 30.

Multiple control files 30 may be generated in order to allow for adaptive bitrate changes due to change in network conditions. This operation is described below. All or a subset of the segments 28 generated by the system may be uploaded to the CDN 26 via the uploader 24 before they are required by the end user device 14. Also, it is not necessary for all segments 28 to be uploaded to the same CDN 26. The user device 14 can be instructed to download from an alternate CDN and an alternate directory.

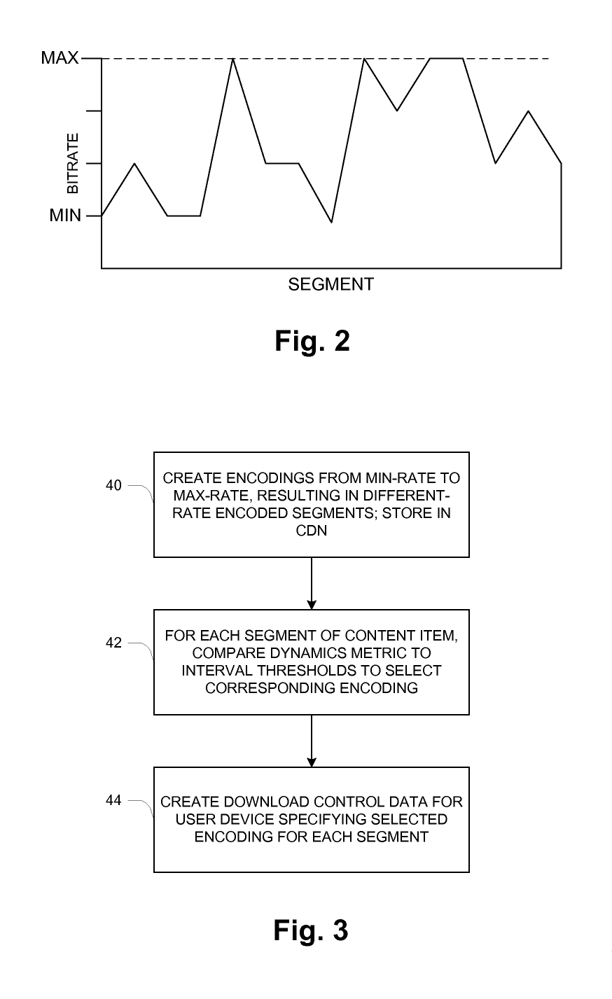

FIG. 2 shows an example bitrate profile for the segments of a content item 10. In this simplified example it is assumed that the content is encoded into four different bitrates over a range from MIN to MAX. The BITRATE value for each segment is the minimum bitrate that can be used to encode the segment with acceptable fidelity, which depends on the level of dynamics (e.g., scene change rate) in the segment. The dotted line at MAX represents one conventional way of delivering the content item, which is using a single encoding at the MAX rate. The space between the profile and the dotted line represents potential savings of download bandwidth, selectively reducing segment bitrates without sacrificing fidelity.

FIG. 3 is a flow diagram of the key aspects of operation in preparing content 10 for segmented delivery to a user device 14 over a network. At 40 a plurality of encodings of a content item are created and stored in a content delivery network 26. The encodings range from a minimum-rate encoding of lowest fidelity to a maximum-rate encoding of highest fidelity. The encodings are created on a segment basis and result in a set of different-rate encoded segments 28-i for each segment of the content item.

At 42, for each segment of the content item, a dynamics metric for the segment is compared to a set of thresholds defining intervals of a dynamic range of the content. The intervals range from a minimum-dynamics interval to a maximum-dynamics interval, where the maximum-dynamics interval representing a maximum level of dynamics and is mapped to a corresponding one of the encodings, and successively lower-dynamics intervals represent successively lower levels of dynamics in the content and are mapped to successively lower-rate ones of the encodings. In the example described by pseudocode above, the thresholds are the discrete values of the variable VALUE which are separated by the fixed STEP amount, and the intervals are the intervals between successive pairs of these discrete values. The comparison at step 42 identifies which interval the dynamics metric of the segment falls into, identifying the corresponding encoding associated with the interval as the encoding to be selected for the segment.

At 44, download control data 30 is created and made available to the user device 14 for use in downloading the content segments 28 from the content delivery network 26 for local rendering. The download control data 30 includes an identification of the selected encoding for each of the segments of the content item.

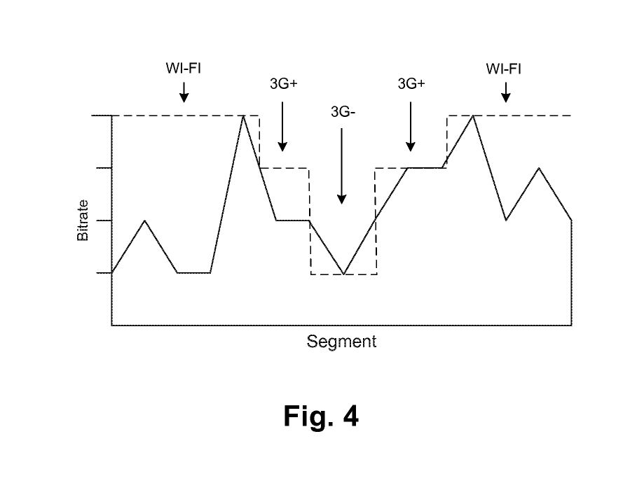

FIG. 4 illustrates an example combined effect when the technique of dynamics-based content delivery is used in an HLS-type environment employing dynamic bitrate switching based on network conditions. The dotted line indicates the HLS effect alone. Operation commences under WiFi-like network conditions where a maximum bitrate may be used. The bitrate is reduced under somewhat worse conditions identified as 3G+. The bitrate is further reduced under even worse conditions identified as 3G−. Bitrate is increased again as network conditions improve back to good WiFi conditions. The identification of 3G and WiFi is only for illustration—the important aspect is prevailing network conditions. Even in WiFi operation, network conditions may vary enough to warrant changes in bitrates as described herein.

FIG. 4 shows the additional effect of bitrate selection based on source content as described herein. In the initial and later WiFi-like periods, the selected bitrate is lower than the maximum bitrate for significant periods due to characteristics of the source content (e.g., low scene change rates). Even during the lower-bandwidth conditions of 3G+, some savings are realized. Overall, significant bandwidth savings may be realized over the selection based on network conditions alone.

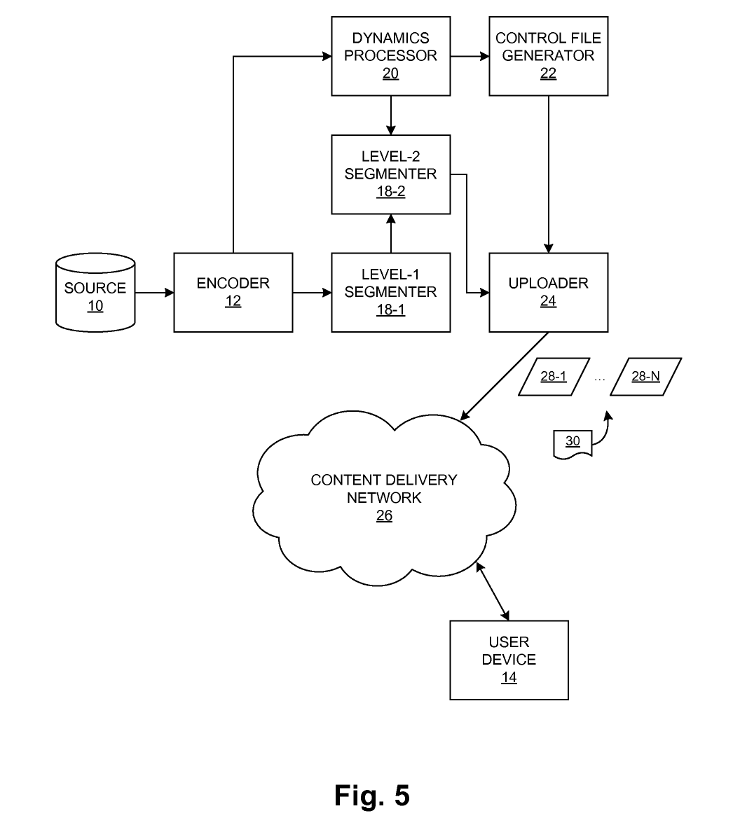

FIG. 5 shows another type of embodiment, similar to that of FIG. 1 but in which the segmentation process is divided up into two phases or levels. A level-1 segmenter 18-1 constructs segments of a first, short duration (such as one second). The level-2 segmenter 18-2 uses the short segments from the level-1 segmenter 18-1 to construct segments of longer duration, such as 10 seconds. This is done by combining the shorter segments from the level-1 segmenter 18-1, either by a method of stitching, concatenation (or both) or some other method of post processing.

The dynamics processor 20 executes an algorithm that uses predefined or dynamic thresholds to calculate the appropriate bitrate segments from the level-1 segmenter 18-1 that should be used to construct the final segments by the level-2 segmenter, thus allowing for optimal playback and network optimization.

An advantage of a system as in FIG. 5 is greater granularity with regard to bitrate selection, i.e. selection of different bitrates within a final (longer) segment and not just on a per segment basis.

There are several general advantages of the techniques described herein:

a) Allows for the characteristics of the source content to be a factor in the decision processing for management of network bandwidth utilization

b) Network bandwidth utilization is reduced with minimal perceived impact on the end user

c) Can be combined with existing adaptive bitrate solutions and technologies to account for non-perfect network conditions.

d) CDN storage space can be reduced by only uploading a subset of the highest bitrate segments

e) Download bandwidth use is reduced where high bitrate segments are not required, thus reducing power consumption and extending battery life of a mobile user device 14

f) May be incremental addition in solutions that already employ segment based delivery using multiple available encodings/bitrates. No additional hardware infrastructure is required, and the technique may scale in line with the existing segment based solution.

g) Provides additional metrics on the source media, allowing verification or classification.

h) Allows for a target total segment output size to be set, with minimal impact on quality and user experience.

As noted, the functional elements of FIG. 1 may be realized by computer hardware executing software, such computer hardware generally including one or more processors, memory and input/output circuitry coupled together by interconnect circuitry such as one or more data buses. Multiple computers may be interconnected by local or wider-area networks as generally known in the art. Software routines or programs in the form of sets of computer program instructions are stored in the memory and retrieved therefrom by the processor(s) where they are executed to realize the corresponding functional elements.

While various embodiments of the invention have been particularly shown and described, it will be understood by those skilled in the art that various changes in form and details may be made therein without departing from the spirit and scope of the invention as defined by the appended claims.

What is claimed is:

1. A method of preparing content for segmented delivery to a user device over a network, comprising:
creating a plurality of encodings of a content item and storing the encodings in a content delivery network, the encodings ranging from a minimum-rate encoding to a maximum-rate encoding, the encodings being created on a segment basis and resulting in a set of different-rate encoded segments for each segment of the content item;
for each segment of the content item, comparing a dynamics metric for the segment to a set of thresholds defining intervals of a dynamic range of the content, the intervals ranging from a minimum-dynamics interval to a maximum-dynamics interval, the maximum-dynamics interval representing a maximum level of dynamics and being mapped to a corresponding one of the encodings, successively lower-dynamics intervals representing successively lower levels of dynamics in the content and being mapped to successively lower-rate ones of the encodings, the comparing resulting in selection of an encoding to which an interval containing the dynamics metric is mapped; and
creating download control data and making it available to the user device for use in downloading the content from the content delivery network for local rendering, the download control data including an identification of the selected encoding for each of the segments of the content item.

2. A method according to claim 1, wherein the content item is a video item and the dynamics metric is a scene change rate reflecting a number of independent video frames occurring in each segment.

3. A method according to claim 1, wherein each encoded segment is formed from a plurality of sub-segments, and wherein the comparing is performed for each sub-segment and the download control data includes an identification of a selected encoding for each of the sub-segments of the content item.

4. A method according to claim 3, wherein each segment represents an interval of the content item in the range of 1-10 seconds, and where there are two or more equal-duration sub-segments per segment.

5. A method according to claim 1, wherein the download control data is contained in a content description file stored in the content delivery network and retrievable therefrom by the user device.

6. A method according to claim 1, further including:
associating each encoding with a corresponding network bandwidth availability for downloading the content; and
including in the download control data the associations between the encodings and the network bandwidth availabilities to enable the user device to modify a selection of an encoding based on network bandwidth availability at a time of downloading a segment.

7. A method according to claim 1, wherein comparing the dynamics metric includes applying a scaling factor based on a known classification of the content item, the classification reflecting a general level of dynamics of the content item.

8. A computer program storage apparatus comprising a non-transitory computer readable medium with a set of computer program instructions recorded thereon, the computer program instructions being operative, when executed by one or more computers of a computer system, to cause the computer system to perform a method of preparing content for segmented delivery to a user device over a network, the method including:
creating a plurality of encodings of a content item and storing the encodings in a content delivery network, the encodings ranging from a minimum-rate encoding to a maximum-rate encoding, the encodings being created on a segment basis and resulting in a set of different-rate encoded segments for each segment of the content item;
for each segment of the content item, comparing a dynamics metric for the segment to a set of thresholds defining intervals of a dynamic range of the content, the intervals ranging from a minimum-dynamics interval to a maximum-dynamics interval, the maximum-dynamics interval representing a maximum level of dynamics and being mapped to a corresponding one of the encodings, successively lower-dynamics intervals representing successively lower levels of dynamics in the content and being mapped to successively lower-rate ones of the encodings, the comparing resulting in selection of an encoding to which an interval containing the dynamics metric is mapped; and
creating download control data and making it available to the user device for use in downloading the content from the content delivery network for local rendering, the download control data including an identification of the selected encoding for each of the segments of the content item.

9. A computer program storage apparatus according to claim 8, wherein the content item is a video item and the dynamics metric is a scene change rate reflecting a number of independent video frames occurring in each segment.

10. A computer program storage apparatus according to claim 8, wherein each encoded segment is formed from a plurality of sub-segments, and wherein the comparing is performed for each sub-segment and the download control data includes an identification of a selected encoding for each of the sub-segments of the content item.

11. A computer program storage apparatus according to claim 10, wherein each segment represents an interval of the content item in the range of 1-10 seconds, and where there are two or more equal-duration sub-segments per segment.

12. A computer program storage apparatus according to claim 8, wherein the download control data is contained in a content description file stored in the content delivery network and retrievable therefrom by the user device.

13. A computer program storage apparatus according to claim 8, wherein the method performed by the computer program further includes:
associating each encoding with a corresponding network bandwidth availability for downloading the content; and
including in the download control data the associations between the encodings and the network bandwidth availabilities to enable the user device to modify a selection of an encoding based on network bandwidth availability at a time of downloading a segment.

14. A computer program storage apparatus according to claim 8, wherein comparing the dynamics metric includes applying a scaling factor based on a known classification of the content item, the classification reflecting a general level of dynamics of the content item.

15. A computer system, comprising:
processing circuitry;
memory;
input/output circuitry; and
interconnect circuitry functionally interconnecting the processing circuitry, memory and input/output circuitry,
the memory storing a set of computer program instructions being operative, when executed by the processing circuitry, to cause the computer system to perform a method of preparing content for segmented delivery to a user device over a network, the method including:
creating a plurality of encodings of a content item and storing the encodings in a content delivery network, the encodings ranging from a minimum-rate encoding to a maximum-rate encoding, the encodings being created on a segment basis and resulting in a set of different-rate encoded segments for each segment of the content item;
for each segment of the content item, comparing a dynamics metric for the segment to a set of thresholds defining intervals of a dynamic range of the content, the intervals ranging from a minimum-dynamics interval to a maximum-dynamics interval, the maximum-dynamics interval representing a maximum level of dynamics and being mapped to a corresponding one of the encodings, successively lower-dynamics intervals representing successively lower levels of dynamics in the content and being mapped to successively lower-rate ones of the encodings, the comparing resulting in selection of an encoding to which an interval containing the dynamics metric is mapped; and
creating download control data and making it available to the user device for use in downloading the content from the content delivery network for local rendering, the download control data including an identification of the selected encoding for each of the segments of the content item.

16. A computer system according to claim 15, wherein the content item is a video item and the dynamics metric is a scene change rate reflecting a number of independent video frames occurring in each segment.

17. A computer system according to claim 15, wherein each encoded segment is formed from a plurality of sub-segments, and wherein the comparing is performed for each sub-segment and the download control data includes an identification of a selected encoding for each of the sub-segments of the content item.

18. A computer system according to claim 17, wherein each segment represents an interval of the content item in the range of 1-10 seconds, and where there are two or more equal-duration sub-segments per segment.

19. A computer system according to claim 15, wherein the download control data is contained in a content description file stored in the content delivery network and retrievable therefrom by the user device.

20. A computer system according to claim 15, wherein the method performed by the computer program further includes:
associating each encoding with a corresponding network bandwidth availability for downloading the content; and
including in the download control data the associations between the encodings and the network bandwidth availabilities to enable the user device to modify a selection of an encoding based on network bandwidth availability at a time of downloading a segment.

21. A computer system according to claim 15, wherein comparing the dynamics metric includes applying a scaling factor based on a known classification of the content item, the classification reflecting a general level of dynamics of the content item.
